(19) United States
(12) Patent Application Publication
(10) Pub. No.: US 2008/0198459 A1
(43) Pub. Date: Aug. 21, 2008

(54) CONJUGATE OPTICS PROJECTION DISPLAY SYSTEM AND METHOD HAVING IMPROVED RESOLUTION

(75) Inventor: James L. Fergason, Menlo Park, CA (US)

Correspondence Address: WARREN SKLAR;RENNER, OTTO, BOISSELLE & SKLAR, LLP, 1621 EUCLID AVE, 19TH FL, CLEVELAND, OH, 44115, US

(73) Assignee: Fergason Patent Properties, LLC, Menlo Park, CA (US)

(21) Appl. No.: 12/022,021

(22) Filed: Jan. 29, 2008

Related U.S. Application Data
(60) Provisional application No. 60/887,147, filed on Jan. 29, 2007.
(60) Provisional application No. 60/887,332, filed on Jan. 30, 2007.

(51) Int. Cl. G02B 5/122

(52) U.S. Cl. 359/529

(57) ABSTRACT

A conjugate optics projection display system includes a beam splitter positioned for viewing an object through the beam splitter and a projector positioned to project an image through the beam splitter, where the projector has a focal plane distance. A retroreflector is optically coupled to the beam splitter and positioned at a distance from the projector, where the distance is less than the focal plane distance of the projector. The retroreflector may include retroreflective elements having a size effective to match or exceed optical resolution requirements of the display system.

### CROSS REFERENCE TO RELATED APPLICATIONS

This application claims priority of U.S. Provisional Application No. 60/887,147, filed on Jan. 29, 2007 and U.S. Provisional Application No. 60/887,332, filed on Jan. 30, 2007, each of which is incorporated herein by reference in its entirety.

### TECHNICAL FIELD

The present invention relates generally to a projection display system, and, more particularly to a conjugate optics projection display system having improved resolution and/or image enhancement.

### BACKGROUND

Several prior conjugate optics systems have been employed for displaying and viewing images. The systems may be head-mounted, in whole or in part, or may be otherwise positioned relative to a viewer. Such systems make use of conjugate optics, for example, including a retroreflector, which may be proximate or relatively remote from the viewer. A RetroVue™ Display System is one example of a conjugate optics system, which has been the subject of several previous, issued U.S. patents, including one or more of U.S. Patent Nos. 5,621,572, 5,808,589, 5,629,806, 5,572,363, 5,606,458, 6,147,805 and 6,379,009, the disclosures of which hereby are incorporated in their entireties. In these conventional displays systems, the image from the projector typically is focused on the retroreflector.

### SUMMARY

In view of the foregoing, the disclosed technology relates to a conjugate optics display system including an array of retroreflectors in which the retroreflectors are configured and sized to match or exceed the optical resolution requirements of the pixels and/or other elements in the optical system. A further aspect relates to the provision of a display system in which a projector and a retroreflector are positioned relative to one another at a distance that is less than the focal plane distance of the projector. The display system provides enhanced resolution and a more compact design.

One aspect of the disclosed technology relates to a display system including a beam splitter positioned for viewing an object through the beam splitter; a projector positioned to project an image through the beam splitter, the projector having a focal plane distance; and a retroreflector optically coupled to the beam splitter and positioned at a distance from the projector, wherein the distance is less than the focal plane distance of the projector.

According to another aspect, the projector is focused at infinity.

According to another aspect, the retroreflector is optically coupled to the beam splitter and comprised of corner cube elements that match or exceed an optical resolution of the projector.

According to another aspect, the retroreflector is optically coupled to the beam splitter and comprised of corner cube elements having a size effective to match or exceed optical resolution requirements of the display system.

According to another aspect, the retroreflector comprises retroreflective elements having a size that corresponds to an effective optical aperture that matches or exceeds effective optical apertures of all other optical elements within the display system.

According to another aspect, the retroreflector is positioned nearer to the projector than the focal plane distance of the projector.

According to another aspect, the display system includes a second beam splitter optically coupled to the first beam splitter; a detector optically coupled to the second beam splitter, wherein the detector receives electromagnetic radiation reflected by the second beam splitter; and wherein the detector is coupled to the projector to provide data to the projector for use in projecting images.

Another aspect of the disclosed technology relates to a projector positioned to project an image onto an eye of a viewer via an optical path that includes a beam splitter and a retroreflector, wherein an image projected by the projector passes through the beam splitter and returns to the beam splitter after reflection by the retroreflector, wherein the retroreflector is positioned at a distance relative to the projector, wherein the distance is less than a focal length of the projector.

According to another aspect, the retroreflector comprises retroreflective elements having a size that corresponds to an effective optical aperture that matches or exceeds effective optical apertures of all other optical elements within the display system.

Another aspect of the disclosed technology relates to a projector positioned to project an image onto an eye of a viewer via an optical path that includes a beam splitter and a retroreflector, wherein an image projected by the projector passes through the beam splitter and returns to the beam splitter after reflection by the retroreflector, wherein the retroreflector includes retroreflective elements having a size that corresponds to an effective optical aperture that matches or exceeds effective optical apertures of all other optical elements within the display system.

According to another aspect, the projector has a focal length that is set at infinity.

Another aspect of the disclosed technology relates to a method of displaying images that includes projecting an image through a beam splitter for reflection by a retroreflector, wherein the retroreflector is positioned at a distance relative to the projector, wherein the distance is less than a focal plane distance of the projector.

According to another aspect, the focal plane distance of the projector is set at infinity.

According to another aspect, the projected image has a resolution; and the retroreflector comprises retroreflective elements having a size that corresponds to an effective optical aperture that matches or exceeds the resolution of the projected image.

Another aspect of the disclosed technology relates to a display system including a retroreflector comprised of corner cube elements having a size of greater than about 0.1 millimeter to about 3 millimeters; and an optical system optically coupled to the retroreflector, wherein the optical system includes a projector and a beam splitter.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is an image of an exemplary diffraction pattern produced by light passing through a circular aperture or by an image pixel;

FIG. 2 is an exemplary intensity profile produced by light passing through a circular aperture or by an image pixel;

FIG. 3 an exemplary intensity profile produced by two adjacent light sources after passing through a circular aperture or by two adjacent image pixels;

FIG. 4 is a schematic illustration of a conjugate optics display system in accordance with aspects of the disclosed technology;

FIG. 5 is a schematic illustration of a solid, large, single element corner cube reflector element having a geometry that may be incorporated into a retroreflector in accordance with the disclosed technology;

FIG. 6 is a schematic illustration of a hollow, large, single element corner cube reflector element having a geometry that may be incorporated into a retroreflector in accordance with the disclosed technology; and

FIG. 7 is a schematic illustration of a conjugate optics display system having three channels, one of which is used to provide information from a non-visible electromagnetic energy source.

### DESCRIPTION AND DISCUSSION OF THE PREFERRED EMBODIMENT

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

As noted above, in conventional systems the projector typically is focused on the retroreflector, where the retroreflector typically is comprised of relatively small corner cube elements, e.g., on the order of about tens of microns. This configuration provides a relative match between the resolution of the projected image and the resolution attributable to the retroreflective sheeting with the projector focused on the retroreflector.

Modern displays and projectors are capable of providing greatly increased resolution compared to conventional displays and projectors. In light of this resolution improvement with today's displays and projectors, it has been discovered that the current conjugate optics design and the retroreflectors employed in the current design now lead to a degradation of the resolution of the display system. Stated differently, it has been discovered that the conventional conjugate optics design and the retroreflectors incorporated in the conventional design unduly limit the overall resolution when used in conjunction with today's higher-resolution projectors.

As such, the invention recognizes problems associated with the conventional conjugate optics display systems, and provides a new design to resolve these problems. As is described more fully below, one aspect of the invention relates to a display system having a projector and a retroreflector that is positioned relative to the projector such that the retroreflector is nearer to the projector than the focal plane of the image provided by the projector. Another aspect of the invention relates to the provision of a retroreflector having corner cube elements that are larger than what is traditionally found in conventional conjugates optics displays. The provision of a projector focused past the retroreflector and the use of larger corner cube elements has been found to provide a conjugate optics display system with improved resolution—resolution that can keep pace with today's modern displays.

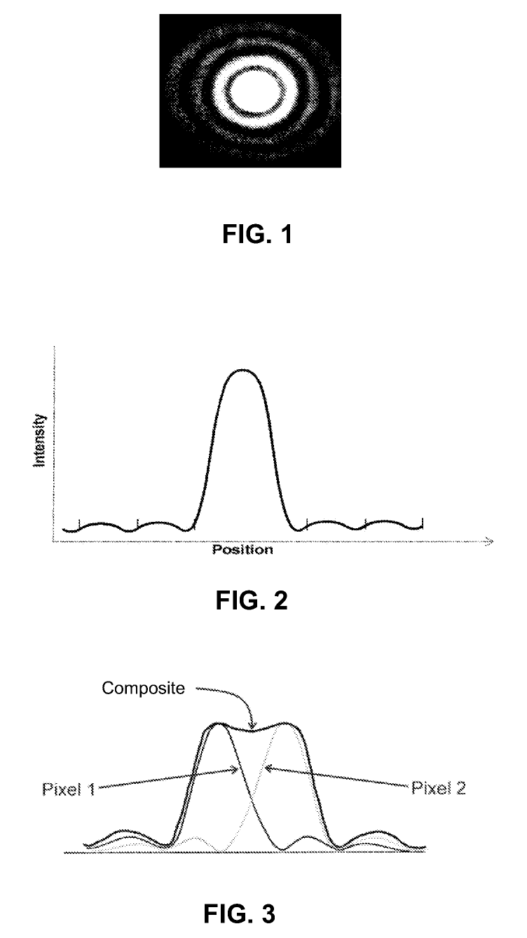

When light from a source passes through a lens (or, more generally, an optical system), the lens also acts as an aperture. Whenever light passes through an aperture, there will be diffraction. An illustration of light passing through a single circular aperture is given in FIG. 1. As illustrated, the diffraction pattern consists of a bright circular disk surrounded by concentric and alternating bright and dark rings. As the diameter of the rings increases, their intensity decreases. This phenomenon is graphically illustrated in FIG. 2. As is described more fully below, it will be appreciated that each pixel of a displayed or projected image may be viewed as a light source passing through a single circular aperture.

The bright central area is known as an Airy disk. It is defined as extending to the first dark ring whose angular size is given by θ=1.22λ/D, where A is the wavelength of light and D is the diameter of the aperture.

A real object or scene can be thought of as being composed of many light sources. It is found that when light from an object composed of many sources is transmitted through a lens, the image consists of a superposition of many Airy disks. The resolution of a detail in the image, therefore, depends on the size of the individual Airy disks. The dimension defined by 1.22λ/D also defines the approximate minimum angular separation between two equal sized point sources such that they can be just barely resolved. The reason for this is that, at this angular separation, the central maximum of one source falls on the first minimum of the other. This is illustrated in FIG. 3, and is known as the Rayleigh limit.

The invention is based, at least in part, on the recognition that in optical systems composed of multiple optical elements, there typically is one component that limits the resolution of the image provided by the system as a whole. Since it is an optical element, the retroreflector in a conjugate optics system introduces an aperture into the optical system. It was discovered that retroreflective sheeting employed in conventional systems effectively limited the overall resolution of the system.

Upon the recognition that each pixel in an image may be viewed as a light source having an aperture giving rise to an Airy disk (governed by θ=1.22λ/D), the invention recognizes that by increasing the effective aperture associated with the retroreflector, D is increased and θ is decreased. This decreased θ corresponds to an increase in overall display system resolution by improving the resolution limit attributable to the retroreflector.

In accordance with this discovery, one aspect of the invention includes a retroreflector that optically matches or exceeds the aperture of the pixels and the other optics in the display system. This effectively removes the retroreflector component as the limiting factor in determining the resolution of the display system.

As is discussed more fully below, the retroreflector may be comprised of individual element, e.g., corner cube elements, having dimensions on the order of greater than about 0.1 millimeter to about 3 millimeters. In a test display system, it was confirmed that the resolution of the display system image clearly improved. It was further found that retroreflectors of this size provide a field of view that was still quite acceptable. In this design, the light from the projector is focused beyond the position of the retroreflector, e.g., at infinity. This enables a more physically compact optical design for the display system.

It will be appreciated that the conjugate optics display system described below may be employed in a variety of different configurations without departing from the scope of the present invention. For example, the display system may be employed in connection with a personal viewer configuration, where the user wears a head-mounted display (HMD) (also referred to as a head-mounted display system or a helmet-mounted display system). The forward looking face, portion or view provided in the HMD unit is semi transparent, e.g., is provided via a semi transparent device, such as, for example, a beam combiner, beam splitter, etc., so that the user can see the surrounding, real world. The HMD unit also integrates a projector consisting of a display and associated optical components. The function of the projector is to produce an image, e.g., a video image, that is in focus and that overlies the image of the real world. The HMD optionally, but typically, may include a head tracker so that the content of the video image can track the features of the real world. Alternatively, the HMD may provide for viewing of only displayed or projected images, e.g., in a virtual reality configuration.

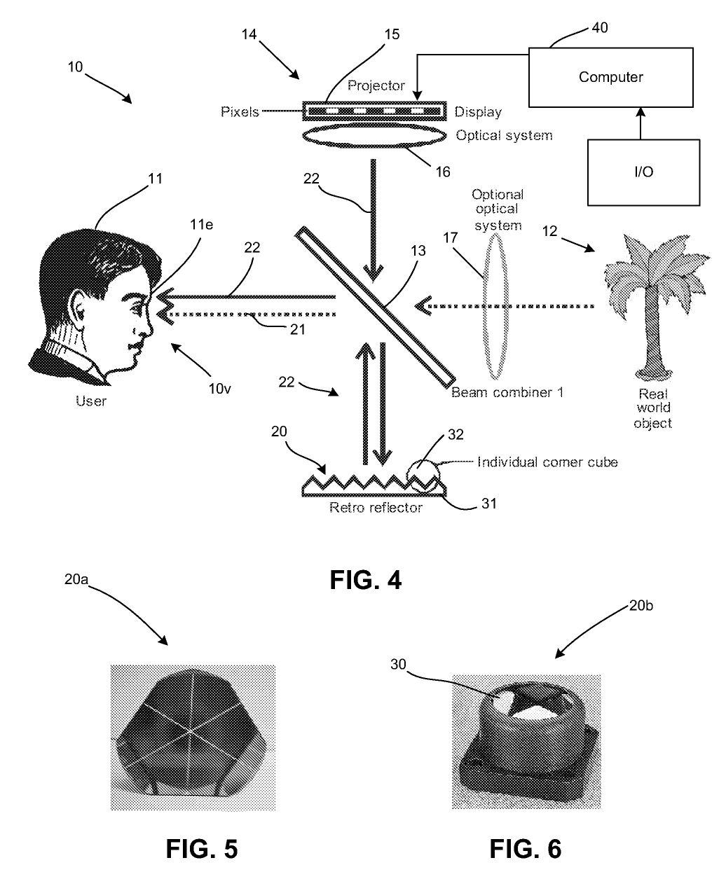

An example of a basic configuration of the display system 10 is illustrated in FIG. 4. The display system 10 in FIG. 4 may be used by a person 11 to view the real world 12 via or otherwise through a beam combiner 13, which combines the real world view for viewing with an image from a projector system 14. As an example, the beam combiner 13 may be a conventional beam splitter that transmits some light incident thereon and reflects some light incident thereon. The projector system 14, for example, may include a conventional display 15, e.g. a liquid crystal display (LCD), cathode ray tube (CRT) display, or other display, and also may include one or more associated optical components 16, e.g., lens, reflector, etc. One or more additional optical components 17, e.g., lens, reflector, etc., also may be used in obtaining the view of the real world 12, as is illustrated in FIG. 4. A retroreflector 20 (also referred to as retroreflective sheeting) reflects light, e.g., images, from the projector system 14 via the beam combiner 13 for viewing by a person 11.

In accordance with one exemplary embodiment in which the user is viewing a real world object in conjunction with a projected image, the principle of operation of the display system 10 is as follows. The user 11 sees the real world 12 by looking directly through beam combiner 13. This can be thought of as a first optical channel 21. In general, the view of the real world 12 will be in the distance (the eye 11e of the person/user 11 focuses at infinity). The second optical channel 22 starts with an image, e.g., a video image, produced and projected by the projector system 14 and focused at infinity. The video image is transmitted through beam splitter 13 and goes on to impact, e.g., to be incident on, the retroreflector 20. Upon retroreflection by the retroreflector 20, the video image is directed back to the beam splitter 13 and is reflected by the beam splitter and directed to the eye of the user. The nature of this retroreflector based optical system is such that the display source, e.g., the projector system 14, and the user's eye 11e as positioned at the viewing area 10v of the system 10 are conjugates, as is described in the above-mentioned patents, which are incorporated herein by reference in their entireties. That is, an image identical to that projected by the projector system 14 is presented to the user's eye 11e.

The display system 10 HMD may be composed of two separate optical systems of the type illustrated in FIG. 4. The two optical systems may share a common retroreflector 20. One optical pathway, and the image it contains, is restricted to view only by the right eye, the other optical pathway and the image it contains is restricted to view only by the left eye. The fact that there are two independent optical systems allows the viewer to see separate right eye and left eye perspective images and thus be presented stereoscopic, 3D imagery. The video images seen in such a two optical system display system may be provided by two different projector systems 14, each respectively providing right eye and left eye images of a stereo pair.

The beam combiner 13 may be in any of several forms, examples of which are, as follows (others also may be possible and used): a plate or pellicle one side of which is coated with a dielectric, visible light mirror; a plate or pellicle one side of which is coated with a reflective or enhanced reflective metal coating; or either a polarizing or an unpolarizing beam combining cube.

In each of these cases, the light impacts the beam combining layer of the beam combiner 13 at an angle of incidence of 45° (45 degrees). The beam combiner 13 can be designed to divide the incident light by 50% transmitted −50% reflected. Alternately, the proportion can be unequal. In addition, other surfaces of each type of beam splitter through which light passes may be coated with a visible light, antireflection (AR) coating.

It may be desirable to include an additional optical system in the first channel optical path 21 through which the user views the real world. In FIG. 4 this optical system is illustrated as optical component 17, e.g., a lens or one or more other optical components, included as an option between the real world 12 and beam combiner 13. In this case, it only affects light the user 11 sees that derives from the real world 12. It is also possible to include the additional optical system, e.g., optical components 17 or other one(s), between beam combiner 13 and the retro-reflector 20 and/or between the beam combiner 13 and the user 11.

The retroreflector 20 is an optical device that sends light back directly to its point of origin, regardless of the light ray's angle of incidence. This is quite different from a mirror, which reflects light rays back to its point of origin only if the mirror is exactly perpendicular to the light beam. An example of a retroreflector is composed of a set of three mutually perpendicular mirrors which form a corner. Hence it is often called a corner cube or corner cube reflector. Examples of single, “large” retro reflecting corner cubes 20a, 20b are illustrated in FIG. 5 and FIG. 6. In FIG. 5, the corner cube 20a is solid and reflection is accomplished by total internal reflection. In FIG. 6 the corner cube 20b is hollow and reflection is accomplished by mirrored surfaces 30.

In a preferred embodiment, the retroreflector 20 is in the form of a thin plastic or metalized plastic sheet 31 containing an array of relatively large, embossed, hexagonally close-packed retroreflector elements 32. In this exemplary embodiment, relatively large means that the diameter of each individual retroreflective element 32 is on the order of greater than about 0.1 millimeters to about 3 millimeters. In another embodiment, each retroreflective element may be on the order of about 1 millimeter to about 5 millimeters. In another embodiment, each retroreflective element may be on the order of 1 millimeter to about 3 millimeters or on the order of about 3 millimeters to about 5 millimeters. As is discussed above, the provision of a retroreflector with relatively large retroreflective elements has been found to increase the resolution of the display system (thereby allowing the display system to provide the resolution increase found in today's displays and projectors).

A computer or other suitable processor 40 may be a source of images for the projector system 14 and/or it may receive input video signals or other signals or images to operate the projector system 14 to present images in the optical channel 22. The computer 40 may be a conventional a programmable digital computer or any other computer, programmable gate array, logic device, application specific integrated circuit (asic), or any other device (collectively referred to as “computer” below) that provides signals to operate the projector system 14. Appropriate input/output devices, e.g., keyboard, mouse, display, memory, power supply, etc. may be provided the computer 40 or may be included as part thereof. Suitable computer program software for the computer 40 to carry out the functions described above may be written by a person having ordinary skill in the art to obtain such operation. Also, it will be appreciated that suitable computer program software may be written by a person having ordinary skill in the art to carry out the various operations and functions that are described herein and equivalents thereof.

While the description provided in connection with the exemplary system of FIG. 4 discusses the projector being focused at infinity, it will be appreciated that the benefits of the display system may be realized when the projector is focused to a distance greater than the distance between the projector and the retroreflector. Stated differently, in a preferred embodiment, the retroreflector is positioned closer to the projector than the focal distance of the projector. Stated still differently, the light from the projector is focused in a plane that is beyond the plane of the retroreflector. This configuration allows for a more compact design that provides enhanced resolution compared to conventional systems.

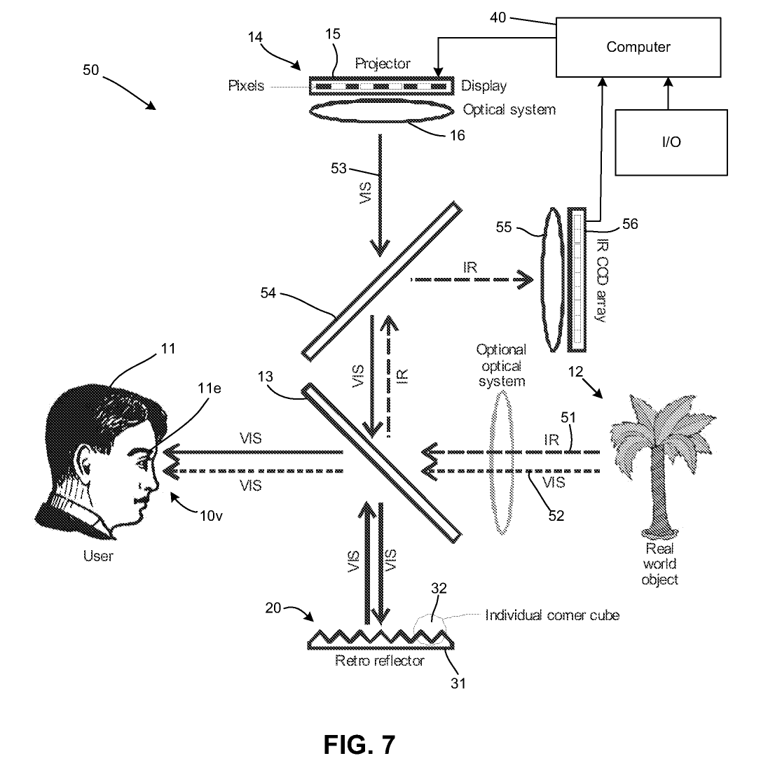

Turning now to FIG. 7, another embodiment of the conjugate optics display system is provided in terms of a head-mounted display (HMD) system 50 (also referred to simply as the display system). In addition to the direct view of the real world 12 and the optical path 16 of the projector system 18 there is now a third optical channel 51. The principle of operation of the disclosed three channel RetroVue configuration 50 is as follows.

Using the features of the disclosed technology, as are shown for the optical system 10 in FIG. 4, utility of the display system 10 is enhanced using infra red/thermally derived imagery that could also be overlaid on the real world view 12. It is possible that imagery from some other non-visible electromagnetic energy in addition to or instead of IR may be used within the spirit and scope of the invention. An example that illustrates the value of such additional information is the following scenario: a soldier wears a helmet with a RetroVue HMD viewing system. The soldier views an inhabited but heavily forested area in which enemy threats are possible. By direct view of the real world, the soldier sees the visible aspects of the scene. This might include buildings, vehicles and landscape features. The projector could be used to overlay and provide other information useful to the soldier. This might include the positions of known, friendly assets or map information. Based on this display capability, the soldier is not receiving all of the information that it is technically possible to provide. A specific example of additional, potentially valuable information that could be provided is an IR/thermal image of the real world view. Such an image can visualize information not otherwise available such as the location of potentially hostile personnel or recently used vehicles that are hidden in the foliage.

The user 11 sees the real world 12 by looking directly through beam splitter (beam combiner) 13. This is the first optical channel 52. In general, the view of the real world 12 will be in the distance (the eye 11e focuses at infinity) and it is visible light and is labeled “VIS.” The second optical channel 53 starts with a visible light (also labeled “VIS”) image, e.g., a moving video image, a still image or some other image, produced and projected by the projector system 14 and focused at infinity. The video image is transmitted through second beam splitter (beam combiner) 54 and beam combiner 13 and goes on to impact the retro-reflector 20. Upon retroreflection by the retroreflector 20, the video image is reflected by beam combiner 13 and directed to the eye 11e of the user 11. The nature of this retroreflector based optical system is such that display source 15 and the user's eye 11e are conjugates. That is, an image identical to that projected by the projector system 14 is presented to the user's eye 11e. The source of the image projected by the projector system 14 can be a visible light video camera, an image generated by a computer or some other source, etc.

The third channel 51 also starts with the real world image 12. In the case of the third channel 51, however, it is the IR content of the real world view that is utilized and the channel is labeled in FIG. 7 “IR.” The IR light is reflected by beam combiner 13 and directed towards beam combiner 54. It is reflected by beam combiner 54, passes through an optical system 55 and impacts an IR sensitive CCD array 56 (or some other suitable IR sensitive detector).

The output of the IR CCD 56 is electronically combined with the other imagery and projected by the projector system 14. Computer 40 may be suitably connected, e.g., as is illustrated, to receive information from the IR detector 56 representing the detected IR image. The computer 40 may combine the IR information and information to the other video image or the like that usually would be provided by the projector system 14, thereby to present the two images or information for the projector system 14 to direct via the second optical channel through the beamsplitters 54, 13, reflection by the retro-reflector 20, and reflection by the beamsplitter 13 to the user 11 for viewing.

Consider the beam combiners that are required to implement the three channel display configuration. In all cases, light impacts the beam combining layers at an angle of incidence of 45°. In addition, the upper surface of the second beam splitter 54 transmits visible light, and, as such, should be coated with a visible light, AR (anti-reflection) coating. The bottom surface of Beam combiner 54 transmits visible light and reflect IR light. This is may be referred to as a hot mirror. The left/lower surface, e.g., facing left and down as seen in the example shown in FIG. 7 of the drawings, of beam combiner 13 needs to both reflect and transmit visible light. That is, it needs to be 50% transmissive in the visible. The right hand/upper surface (facing right and up) of beam combiner 13 is configured to reflect IR light, but transmit visible light. Once again, this may be referred to as a hot mirror.

The three-channel display system 50 may be composed of two separate optical systems of the type illustrated in FIG. 7. The two optical systems may share a common retroreflector. One optical pathway and the image it contains is restricted to view only by the right eye, the other optical pathway and the image it contains is restricted to view only by the left eye. The fact that there are two independent optical systems allows the viewer to see separate right eye and left eye perspective images and thus be presented stereoscopic, 3D imagery. It is also possible to omit 3D capability for the IR image and include a third channel in only one eye of the HMD.

As is described above with respect to FIG. 4, the display system 50 is configured such that the light from the projector 15 is focused at a plane that is beyond the plane of the retroreflector 20, e.g., light from the projector is focused at infinity. Additionally or alternatively, the retroreflector is comprised of individual elements, e.g., corner cube elements, having dimensions on the order of greater than about 0.1 millimeter to about 3 millimeters. As is discussed above, the provision of larger retroreflective elements increase overall system resolution. In addition, a design that focuses light from the projector beyond the retroreflector, e.g., at infinity, enables a more physically compact optical design for the display system.

While the description provided in connection with the exemplary system of FIG. 7 discusses the projector being focused at infinity, it will be appreciated that the benefits of the display system may be realized when the projector is focused to a distance greater than the distance between the projector and the retroreflector. Stated differently, in a preferred embodiment, the retroreflector is positioned closer to the projector than the focal distance of the projector. Stated still differently, the light from the projector is focused in a plane that is beyond the plane of the retroreflector. This configuration allows for a more compact design that provides enhanced resolution compared to conventional systems.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

As will be appreciated by one of ordinary skill in the art, computer program elements and/or circuitry elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A display system comprising:
a beam splitter positioned for viewing an object through the beam splitter;
a projector positioned to project an image through the beam splitter, the projector having a focal plane distance; and
a retroreflector optically coupled to the beam splitter and positioned at a distance from the projector, wherein the distance is less than the focal plane distance of the projector.

2. The display system of claim 1, wherein the projector is focused at infinity.

3. The display system of claim 1, wherein the retroreflector is optically coupled to the beam splitter and comprised of corner cube elements that match or exceed an optical resolution of the projector.

4. The display system of claim 1, wherein the retroreflector is optically coupled to the beam splitter and comprised of corner cube elements having a size effective to match or exceed optical resolution requirements of the display system.

5. The display system of claim 1, wherein the retroreflector comprises retroreflective elements having a size that corresponds to an effective optical aperture that matches or exceeds effective optical apertures of all other optical elements within the display system.

6. The display system of claim 5, wherein the retroreflective elements are corner cube elements having a size of greater than about 0.1 millimeters to about 3 millimeters.

7. The display system of claim 1, wherein the retroreflective elements are corner cube elements having a size of about 1 millimeter to about 3 millimeters.

8. The display system of claim 1, wherein the projector is focused at infinity and positioned to focus at infinity relative to the retroreflector.

9. The display system of claim 1, wherein the retroreflector is positioned nearer to the projector than the focal plane distance of the projector.

10. The display system of claim 1, further comprising:
a second beam splitter optically coupled to the first beam splitter;
a detector optically coupled to the second beam splitter, wherein the detector receives electromagnetic radiation reflected by the second beam splitter; and
wherein the detector is coupled to the projector to provide data to the projector for use in projecting images

11. The display system of claim 10, wherein the detector is configured to detect non-visible electromagnetic radiation corresponding to the object, and based on the detected non-visible electromagnetic radiation, the projector projects an image in the visible range.

12. The display system of claim 11, wherein the detector is configured to detect infrared or ultraviolet light.

13. The display system of claim 10, wherein the retroreflector comprises retroreflective elements having a size that corresponds to an effective optical aperture that matches or exceeds effective optical apertures of all other optical elements within the display system.

14. The display system of claim 13, wherein the retroreflective elements are corner cube elements having a size of greater than about 0.1 millimeters to about 3 millimeters.

15. The display system of claim 1, wherein the display system is integrated into a head-mounted display device.

16. A display system comprising:
a projector positioned to project an image onto an eye of a viewer via an optical path that includes a beam splitter and a retroreflector, wherein an image projected by the projector passes through the beam splitter and returns to the beam splitter after reflection by the retroreflector, wherein the retroreflector is positioned at a distance relative to the projector, wherein the distance is less than a focal length of the projector.

17. The display system of claim 16, wherein the retroreflector comprises retroreflective elements having a size that corresponds to an effective optical aperture that matches or exceeds effective optical apertures of all other optical elements within the display system.

18. The display system of claim 17, wherein the retroreflective elements are cube corner elements having a size of greater than about 0.1 millimeters to about 3 millimeters.

19. The display system of claim 16, wherein the focal length of the projector is set at infinity.

20. A display system comprising:
a projector positioned to project an image onto an eye of a viewer via an optical path that includes a beam splitter and a retroreflector, wherein an image projected by the projector passes through the beam splitter and returns to the beam splitter after reflection by the retroreflector, wherein the retroreflector includes retroreflective elements having a size that corresponds to an effective optical aperture that matches or exceeds effective optical apertures of all other optical elements within the display system.

21. The display system of claim 20, wherein the projector has a focal length that is set at infinity.

22. The display system of claim 21, wherein the retroreflective elements are corner cube elements having a size of greater than about 0.1 millimeters to about 3 millimeters.

23. A method of displaying images comprising:
projecting an image through a beam splitter for reflection by a retroreflector, wherein the retroreflector is positioned at a distance relative to the projector, wherein the distance is less than a focal plane distance of the projector.

24. The method of claim 23, wherein the focal plane distance of the projector is set at infinity.

25. The method of claim 25, wherein the projected image has a resolution; and wherein the retroreflector comprises retroreflective elements having a size that corresponds to an effective optical aperture that matches or exceeds the resolution of the projected image.

26. A display system comprising:
a retroreflector comprised of corner cube elements having a size of greater than about 0.1 millimeter to about 3 millimeters; and
an optical system optically coupled to the retroreflector, wherein the optical system includes a projector and a beam splitter.
